(19) United States
(12) Patent Application Publication
(10) Pub. No.: US 2007/0027904 A1
(43) Pub. Date: Feb. 1, 2007

(54) System and method for translating between relational database queries and multidimensional database queries

(76) Inventors: George Chow, Vancouver (CA); Darryl Eckstein, Vancouver (CA); Bruce Johnston, Vancouver (CA)

Correspondence Address: GOWLING LAFLEUR HENDERSON LLP (VAN 1), PO BOX 49122 SUITE 2300, 1055 DUNSMUIR STREET, VANCOUVER, BC, VZX 1J1, CA

(21) Appl. No.: 11/473,018

(22) Filed: Jun. 23, 2006

Related U.S. Application Data
(60) Provisional application No. 60/693,410, filed on Jun. 24, 2005.

(51) Int. Cl. G06F 7/00

(52) U.S. Cl. 707/102

(57) ABSTRACT

A method for mapping a data source of an unknown configuration to that of a known configuration, comprising the steps of submitting a request for metadata to the data source of the unknown configuration; generating a relational schema from the known configuration based on the metadata received from the data source of the unknown configuration; and returning the metadata of the generated relational schema which maps the data source of the unknown configuration to the known configuration. In a preferred embodiment data source of the unknown configuration is a multidimensional database and the known configuration is a star or snowflake relational schema.

### CROSS REFERENCE TO RELATED APPLICATIONS

This application claims priority from U.S. provisional application Ser. No. 60/693,410 filed Jun. 24, 2005 and is incorporated herein by reference.

### BACKGROUND OF THE INVENTION

1. Field of the Invention

This invention relates to the field of online analytical processing (OLAP), and more particularly to a system and method for allowing OLAP and non-OLAP tools to access diverse multidimensional databases.

2. Description of the Related Art

On-Line Analytic Processing (OLAP) and Decision Support Systems (DSS) enable executives in gaining insight into data by providing fast, interactive access to a variety of possible views of information.

These systems depend on access to good, consistent data, usually contained in a data warehouse. A data warehouse consolidates data from an organization's wide range of databases and data sources. The data warehouse is but one component of an OLAP system. An OLAP system provides functions which range from basic navigation and browsing (often known as “slice and dice”), and calculations, to more serious analyses such as time series and modeling.

OLAP systems are sometimes implemented by moving data into specialized databases (the data warehouse), which are optimized for providing OLAP functionality. In many cases, the receiving data storage is multidimensional in design.

A multidimensional database (MDB) is a type of database that is optimized for data warehouses and OLAP applications.

OLAP systems are used to define multidimensional cubes, each with several dimensions, i.e., hypercubes, and should support operations on the hypercubes. The operations include for example: slicing, grouping of values, drill-down, roll-up and the viewing of different hyperplanes or even projections in the cube, algebraic operations and aggregate-type operations.

MDB's are almost exclusively created using input from existing relational databases. Hence most OLAP sysem have built in tools or interfaces for reading in data from relational databases into the OLAP cube.

In this regard, referring to FIG. I there is shown a general outline of a datawarehouse. Information is first extracted from operational sources and then cleaned, transformed and loaded (ETL) by a separate server into the data warehouse. Often, production data derived from OLTP (Online Transaction Processing) systems resides in a collection of remote, heterogeneous repositories and must undergo considerable massaging before it can be integrated into a single clean store.

Once the data has been culled from the remote sources, it is placed into the data warehouse, which at this point in time is almost always a relational database. The data warehouse itself may be constructed as a monolithic enterprise-wide entity and/or a series of data marts, each containing some subset of the corporate data. In either case, it will be the job of an OLAP server to actually supply analytical functionality for the DSS system.

In practice, there are two forms of OLAP servers, known as ROLAP (Relational OLAP) and MOLAP (Multidimensional OLAP). The distinction relates to how the system is organized internally. Conceptually, their aims are similar.

Finally, front end tools provide a user-friendly (often graphical) interface to the knowledge workers who will exploit the system.

ROLAP databases are often ordered in a well-known star or snowflake scheme wherein a central primary table denoted a fact table is related to a number of secondary tables denoted dimension tables. One fact table is related to many dimension tables. A fact table contains the data on which calculations are based. Data in a fact table contain the most detailed information. The dimension tables contain data upon which it is desired to group calculations. Data in a table resulting from calculations based upon other tables are denoted aggregated data.

Using Open Database Connectivity (ODBC), data can be imported from existing relational databases to create a multidimensional database for OLAP.

Two leading OLAP products are Hyperion Solution's Essbase and Oracle's Express Server. Hyperion Essbase via Essbase Integration Services (EIS) provides a metadata-driven environment to integrate business analysis applications built on Hyperion Essbase with detailed data stored in relational databases. The EIS provides a suite of graphical tools, data integration services, and a metadata catalog that dramatically reduce the time and expense of creating, deploying, and managing business analysis applications. EIS provides a way to move data and metadata from all the leading relational databases, including IBM DB2, Oracle, Teradata, Microsoft SQL Server, Sybase, and Informix into Hyperion Essbase.

One of the problems with the OLAP market is that it is a growing but fragmented market. Interoperability between competing products has been non-existent or minimal due to non-standardized API (Application Program Interface) and other such underlying technologies and competitive pressures. The leading query language for multidimensional databases is MDX, which was created to query OLAP databases, and has become widely adopted within the realm of analytical applications. MDX forms the language component of OLE DB for OLAP, and was designed by Microsoft Corp. as a standard for issuing queries to multidimensional data sources.

Broad ranges of software tools are available to OLAP users to provide multidimensional conceptual views of data, operations on dimensions, aggregation, intuitive data manipulation and reporting. However these tools are expensive and often not interoperable with the OLAP market's range of proprietary MDB implementations.

Accordingly, there is a need to address this interoperability limitation.

### SUMMARY OF THE INVENTION

An advantage of the present invention is that it enables a multidimensional database to source its data from multidimensional databases of differing types thereby providing interoperability between databases from different database vendors.

Another advantage of the present invention is that it enables relational database tools that do not specifically support multi-dimensional databases, to be used with multi-dimensional databases. For example Microsoft Excel's SQL capability of can be used with an embodiment of this invention to read multidimensional data sources.

The present invention leverages functionality of current OLAP servers which issue SQL queries to import data from relational databases, by using this existing functionality to migrate data residing in a source OLAP cube to a destination OLAP cube so that analysis tools operable on the destination OLAP cube can be used on the source OLAP cube data.

In a broad aspect the present invention provides systems, methods and interfaces for translating relational database queries into multidimensional database queries. Typically, these relational queries are SQL queries while the multidimensional database queries are MDX queries.

In accordance with a first aspect of the present invention there is provided a method for mapping a data source of an unknown configuration to that of a known configuration, comprising the steps of:

a. submitting a request for metadata to the data source of the unknown configuration;

b. generating a relational schema from the known configuration based on the metadata received from the data source of the unknown configuration; and

c. returning the metadata of the generated relational schema which maps the data source of the unknown configuration to the known configuration.

An embodiment of the first aspect provides for the data source of the unknown configuration to be a multidimensional database.

A further embodiment of the first aspect provides for the known configuration to be a star or snowflake relational schema.

An advantage of the present invetion is that it allows the dynamic addition of new cubes to the data source.

In a further embodiment of the first aspect the method includes the steps of:

a. receiving, from a data consumer, a query for data against the generated relational schema;

b. translating the received query to one or more queries supported by the data source for retrieval of data from the data source; and

c. returning the data retrieved from the data source to the data consumer.

A second aspect of the present invention provides for a method for translating a query submitted to a data source, wherein the query is in an unsupported language of the data source, the method comprising:

a. receiving a query from a data consumer, the query being based on a schema of a known configuration;

b. translating the received query to one or more queries supported by the data sources for retrieval of data from the data sources by use of a schema generated from said known configuration and metadata from said data sources; and

c. returning the retrieved data from said data sources to the data consumer.

A third aspect of the present invention provides for an adapter for translating a query, issued by a data consumer in an unsupported language of a data source, to that of the data source supported language, said adapter comprising:

a. means for generating a relational schema of a known configuration;

b. an interface for receiving a query against said known configuration;

c. a metadata model containing model objects that represent the data sources;

d. a transform algorithm for presenting the data consumer with said data source in said known configuration.

An embodiment of the various aspects provides for the data source of the unknown configuration to be a multidimensional database, the known configuration to be a star or snowflake relational schema, the supported language of the data source being MDX and the unsupported language being SQL.

In one embodiment of the present invention the adapter is an ODBC driver that takes SQL as input and executes MDX queries against a multidimensional data source.

In a still further embodiment of the present invention the adapter presents a view based on a notional set of relational tables, in a star or snowflake schema of a multidimensional cube for import into an OLAP database system. In a still further embodiment, the multidimensional cube is a SAP BW (Business Information Warehouse) cube and the OLAP database system is a Hyperion Essbase with Essbase Integration Services (EIS).

In a specific embodiment, the adapter is an ODBC driver which is accessed via ODBC, JDBC or OLE-DB.

### BRIEF DESCRIPTION OF THE DRAWINGS

An embodiment or embodiments will now be described by way of example only with reference to the following drawings in which:

FIG. 1 is a schematic diagram showing functional layers of a data warehouse;

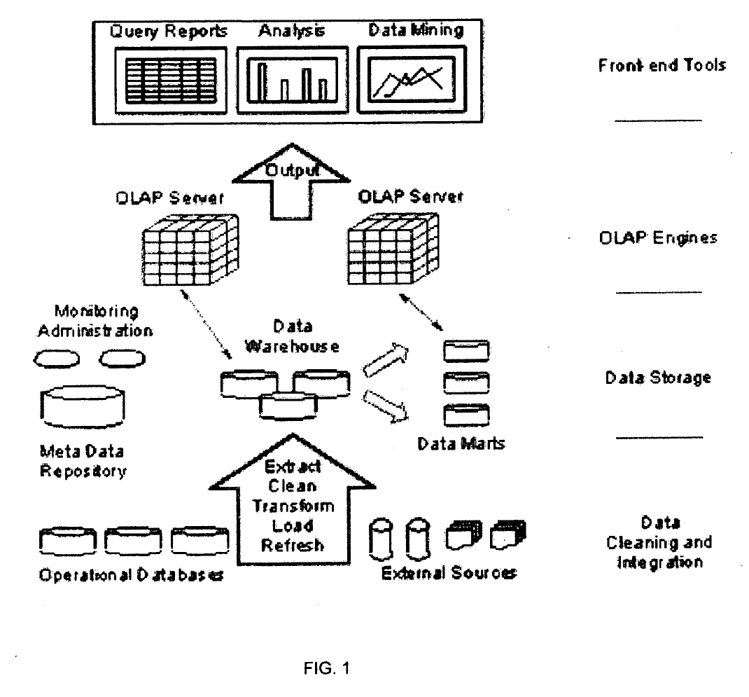

FIG. 2 shows a block diagram of functional layers of an embodiment of the adapter according to the present invention;

FIG. 3 shows a high-level view of the architecture of the adapter and showing it's a typical usage scenario;

FIG. 4 shows a schematic of a use case for the adapter;

FIG. 5 shows a representation of a cube using relational tables;

FIG. 6 shows a simple hierarchy from which to construct tables;

FIG. 7 shows a relational schema that would be generated for a simple cube with three dimensions, and one hierarchy;

FIG. 8 shows a conceptual flow diagram of an data record manager according to an embodiment of the present invention;

FIG. 9 shows a portion of one implementation of an OLAP-relational schema for a cube; and

FIG. 10 shows part of the OLAP-relational schema for an SAP Time table.

### DETAILED DESCRIPTION OF PREFERRED EMBODIMENTS

The following are incorporated by reference:
[GoF95] E. Gamma, R. Helm, R. Johnson, J. Vlissides: Design Patterns—Elements of Reusable Object-Oriented Software, Addison-Wesley, 1995
[POSA1] F. Buschmann, R. Meunier, H. Rohnert, P. Sommerlad, M. Stal: Pattern-Oriented Software Architecture—A System of Patterns—Volume 1, Wiley, 1996
[DevGuide] Simba Technologies: Development Guide For Windows

In the following description like numerals refer to similar structures in the figures. The following definitions introduce concepts that reflect the multidimensional view and are basic to OLAP:

A “dimension” is a structure that categorizes data. Commonly used dimensions include customer, product, and time. Typically, a dimension is associated with one or more hierarchies. Several distinct dimensions, combined with measures, enable end users to answer business questions. For example, a Time dimension that categorizes data by month helps to answer the question, “Did we sell more widgets in January or June?”

A “measure” includes data, usually numeric and additive, that can be examined and analyzed. Typically, one or more dimensions categorize a given measure, and it is described as “dimensioned by” them.

A “hierarchy” is a logical structure that uses ordered levels as a means of organizing dimension elements in parent-child relationships. Typically, end users can expand or collapse the hierarchy by drilling down or up on its levels.

A “level” is a position in a hierarchy. For example, a time dimension might have a hierarchy that represents data at the day, month, quarter, and year levels.

An “attribute” is a descriptive characteristic of the elements of a dimension that an end user can specify to select data. For example, end users might choose products using a Color attribute. Some attributes can represent keys or relationships into other tables.

A “query” is a specification for a particular set of data, which is referred to as the query's result set. The specification may require selecting, aggregating, calculating, or otherwise manipulating data. If such manipulation is required, it is an intrinsic part of the query.

A “schema” is a collection of relational database objects. Two types of schemas are characteristic of a data warehouse: a star schema and a snowflake schema. A star schema comprises one or more fact tables related to one or more dimension tables. The relationships are defined through foreign keys and metadata. A snowflake schema is a star schema that has been partially or fully normalized to reduce the number of duplicate values in the dimension tables.

For example, a star schema might have a single Geography dimension table with four columns: City, State, Region, and Country. Only the City column has predominately unique values, while the other columns have increasing numbers of duplicate values. A snowflake schema might have three related geography dimension tables: One table with two columns (City and State) that define the relationship between cities and states, a second table with two columns (State and Country) that define the relationship between states and countries, and a third table with two columns (Region and Country) that define the relationship between regions and countries.

A “cube” is a logical organization of multidimensional data. Typically, the dimension of a cube contain dimension values, and the body of a cube contains measure values. For example, sales data can be organized into a cube whose dimensions contain values from the time, product, and customer dimensions and whose body contains values from the sales measure.

“Metadata”—Typically, an OLAP application employs a different conceptual model than that of the relational database that warehouses the information to be analyzed. Therefore, when the OLAP application runs, the required data is fetched from the relational database and converted into a multidimensional form that the OLAP application can use. For the data to be fetched and processed correctly, the relational database columns that are to be fetched and the role of those columns must be identified. This identification is made by metadata.

Metadata is data that describes the data and objects in the relational database for fetching and computing the data correctly. Generally, metadata can be taken to mean the fact that a data source exists, as well as the structure and characteristics of the data in that data source. For example, the facts that a unitsSold measure exists, that the unitsSold measure contains numeric values, and that the unitsSold measure is dimensioned by geography and product are considered metadata. By contrast, the fact that 30 widgets were sold in 1998 in Tallahassee, Fla. is considered to be data. Concerning dimension members, the facts that a geography dimension exists and that it contains string values as members are other examples of metadata, but the fact that geography contains the particular string “Tallahassee, Fla.” is data. Similarly, the fact that there is a hierarchy called standard defined against geography, and that it contains three levels called city, state, and region, are all considered metadata, but the fact that “Tallahassee, Fla.” is a child of “Fla.” is considered to be data.

Accordingly, metadata is used to inform the OLAP application about the data that is available within the relational database in a manner so that the OLAP application can define multidimensional objects for analysis. When the OLAP application runs, the OLAP application instantiates these multidimensional objects and populates them with data fetched from the database.

The basic data model in a relational database is a table comprising one or more columns of data. All of the data in a relational database table is stored in columns. In contrast, the basic multidimensional data model is a cube, which comprises measures, dimensions, and attributes. Accordingly, it is important to identify whether the data from a particular column in the relational database will function as a measure, a dimension, or an attribute in the multidimensional form. In addition, it is important to have the metadata identify which columns are keys for indexing and fetching data from the relational database tables. These decisions are stored as metadata and constraints.

More specifically, the metadata will define the multidimensional measures to correspond to the facts stored in relational database tables. The term “fact” is typically used in relational databases, and the term “measure” is typically used in multidimensional applications. Measures are thus located in fact tables. A fact table typically has two types of columns: measures (or facts) and foreign keys to dimension tables. Measures contain the data to be analyzed, such as Sales or Cost. One implementation of the present invention requires that a column have a numerical or date data type to be identified as a measure. Most frequently, a measure is numerical and additive. One or more columns in the dimension tables form constraints on the fact tables. These constraints are defined by foreign keys in the fact tables, by the metadata, or both.

Dimensions identify and categorize the OLAP application's data. In a relational database system, dimension members are stored in a dimension table. Each column represents a particular level in a hierarchy. In a star schema, the columns are all in the same table; in a snowflake schema, the columns are in separate tables for each level. Because measures are typically multidimensional, a single value in a measure must be qualified by a member of each dimension to be meaningful. For example, a Sales measure might have dimensions for Product, Geographic Area, and Time. A value in the Sales measure (37854) is only meaningful when it is qualified by a product (DVD Player), a geographic area (Pacific Rim), and Time (March 2001). Defining a dimension in the data warehouse creates a database dimension object, in addition to creating metadata. A dimension object contains the details of the parent-child relationship between columns in a dimension table; it does not contain data. The database dimension object is used by the Summary Advisor and query rewrite to optimize the data warehouse. However, on the multidimensional side, a dimension does contain data, such as the names of individual products, geographic areas, and time periods. The OLAP API uses the metadata, dimension objects, and dimension tables to construct its dimensions.

A hierarchy is a way to organize data according to levels. Dimensions are structured hierarchically so that data at different levels of aggregation can be manipulated together efficiently for analysis and display. Each dimension must have at least one level. Each level represents a position in the hierarchy. Levels group the data for aggregation and are used internally for computation. Each level above the base (or lowest) level represents the aggregate total of the levels below it. For example, a Time dimension might have Day, Week, Quarter, and Year for the levels of a Time dimension hierarchy. If data for the Sales measure is stored in days, then the higher levels of the Time dimension allow the Sales data to be aggregated correctly into weeks, quarters, and years. The members of a hierarchy at different levels have a one-to-many parent-child relationship. For example, “QTR1” and “QTR2” are the children of “YR2001,” thus “YR2001 ” is the parent of “QTR1” and “QTR2”. If more than one hierarchy is defined for a dimension, then the hierarchies must have the same base level. For example, two hierarchies might be defined for a Time dimension, one for the calendar year and another for the fiscal year. Both hierarchies would use Day for the base level. All levels of a dimension are stored in dimension tables. A dimension can have multiple hierarchies, but all of them must have the same base level. The values of that level are stored in the key used to join the dimension table to a fact table.

Attributes provide supplementary information about the dimension members at a particular level. Attributes are often used for display, since the dimension members themselves may be meaningless, such as a value of “T296” for a time period. For example, there might be columns for employee number (ENUM), last name (LAST_NAME), first name (FIRST_NAME), and telephone extension (TELNO). ENUM is the best choice for a level, since it is a key column and its values uniquely identify the employees. ENUM also has a NUMBER data type, which makes it more efficient than a text column for the creation of indexes. LAST_NAME, FIRST_NAME, and TELNO are attributes. Even though they are dimensioned by ENUM, they do not make suitable measures because they are descriptive text rather than business measurements. Attributes are associated with a particular level of a dimension hierarchy and must be stored in the same table as that level.

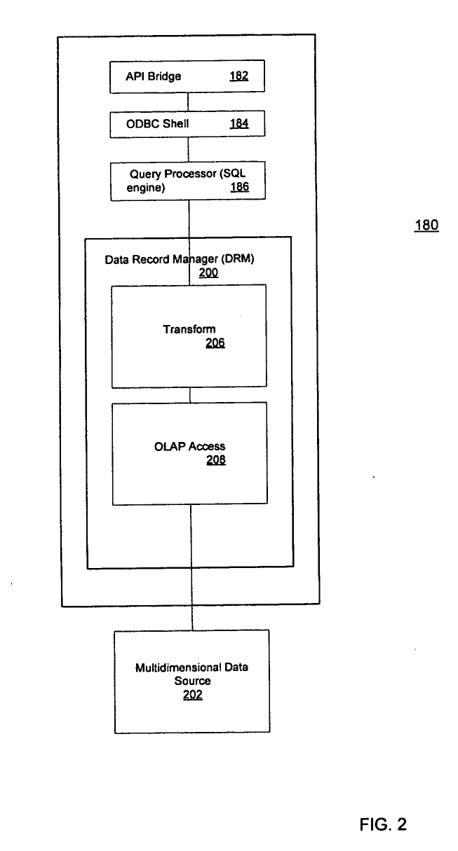

Referring to FIG. 2 there is shown an architecture for an adapter 180 for translating a query, issued by a data consumer, to that of a data source 202, according to an embodiment of the present invention. The adapter includes an API bridge 182 (which is configured to a particular connectivity, such as JDBC), an ODBC shell 184, which provides a data access interface for Windows or Unix applications to access data, a query processor 186, typically an SQL engine, for processing ODBC function calls, parsing the SQL statements and generating an optimal plan for accessing data through a database record manager (DRM) 200 which in turn provides a set of low-level functions for mapping to the data source 202. The DRM 200 is transforms SQL requests received via the query processor 186 to OLAP access queries for accessing the multidimensional data source 202. The DRM is customized for each data source Novel aspects of the the adapter 180 will be explained in more detail later. It may be appreciated that the API bridge 182, the ODBC shell 184 and query processor 186 are typically well known in the art and will not be discussed in detail. An example of an implementation of the query processor 186 is an SQL engine known as the SimbaEngine by Simba Technologies which supports the ODBC2.5 standard and SQL-92 syntax.

At the core of the adapter is the DRM 200 which comprises a transform layer 206 and an OLAP access layer 208. In one embodiment, the transform layer 206 presents a virtual star or snowflake scheme to the query engine 186. Underneath the transform layer 206 is the OLAP access layer 208 that communicates with the multidimensional data source 202. The OLAP access layer 208 encapsulates the details involved in working with a particular multidimensional data source 202. The present embodiment is described with respect to a multidimensional data source 202 that supports the MDX language, but the adapter of the present invention could be extended to communicate with any multidimensional data source.

A specific implementation of the invention will be described with respect to providing an ODBC driver to connect to an SAP BW with the Hyperion Essbase Integration Services(EIS). The ODBC driver was developed using the SimbaEngine referenced earlier which is an SDK for developing ODBC drivers.

As mentioned earlier, MDX is the most common language used to communicate with multidimensional data sources and is currently supported by SAP BW, Microsoft Analysis Services, Hyperion Essbase, Applix iTMl, MIS Alea, INEA, Aleri, Armstrong Laing EPO, Descisys TeraSolve, etc.

While MDX is a query language, the access protocol used to connect to MDX data sources is OLE DB for OLAP (ODBO) or XML for Analysis (XMLA). Accordingly, the adapter according to the present invention can connect to any MDX data source via ODBO or XMLA.

Operationally, the adapter 180 presents a star or snowflake view of a cube. A data consumer generates an SQL queries against the virtual star/snowflake. The adapter 180 parses the SQL statement and generates appropriate MDX statement(s) to fulfill the SQL statements. Whenever multiple MDX statements are required, the adapter assembles the results back together.

In an embodiment the adapter 180 may be optimized to reduce the amount of data requested and to defer as much processing to the MDX engine of the data source and reduce the amount of work needed to be done by adapter 180.

As mentioned earlier, the transform engine 206 maps the metadata of a cube to a star/snowflake schema. The adapter 180 responds to an SQL string and is able to map or translate the SQL string to one or more MDX statements and generates MDX statements. The adapter is able to process a join statement and filters the data returned by the MDX statement(s) so that the resulting data is exactly what the SQL statement request.

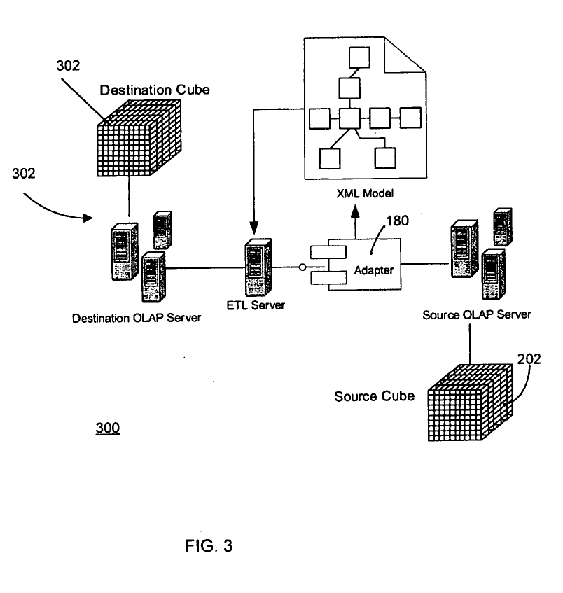

Referring to FIG. 3 there is shown a high-level view of an architecture for using the adapter 180 to import into a destination cube 301 in an OLAP system 302, such as Hyperion Essbase via EIS, from a source multidimensional database 202 such as SAP BW. The following describes scenarios and actions from the OLAP system 302 to the adapter 180; mapping of the multidimensional database concepts to a relational schema useable from the OLAP system via the ODBC interface; data flow within the adapter 180 to fulfill the mapping described above and an understanding of the division of responsibilities and data flow in the adapters subsystems.

In a preferred embodiment, the adapter supplies an XML model 304 of the relational schema to simplify the process of modeling a multidimensional cube within the OLAP system.

Below, we describe the DRM 200 from a conceptual and a subsystem view. The conceptual view will describe the data model and its transformations from one process to another. The subsystem view is a concrete perspective on the data model and provides an encapsulation of functionality into more discrete concrete concepts.

As stated earlier the adapter is an ODBC driver that maps a multidimensional schema to a relational schema. This enables the OLAP system to load data from the multidimensional cube using the ODBC interface. The process of using the adapter with, for example, EIS will be similar to using any other ODBC driver with the exception of a wizard that will guide the user through the process of selecting a cube from the warehouse and ultimately generating the XML model. The operation of the adapter can best be understood by first referring to the following use cases.

Use-Cases

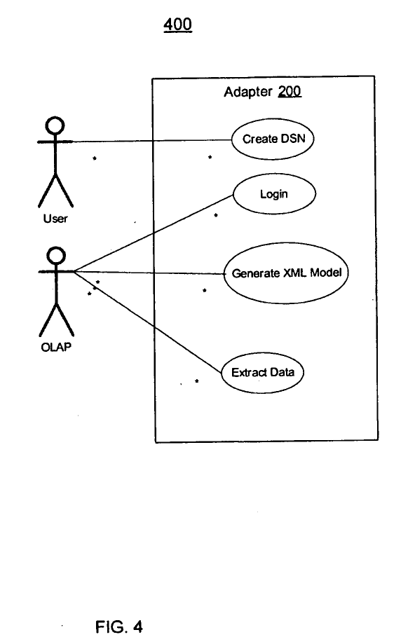

The following outlines the basic use-cases that the adapter satisfies. The main activities involved in using the adapter include creating a DSN, logging into the adapter, building an OLAP model, and extracting data. The OLAP system will be able to automatically import the XML model that the adapter will generate. FIG. 4 shows a basic use case 400. It is to be noted that various standards and protocols exist for connecting to databases and similarly for analysis tools. As mentioned earlier the use cases of the present invention will be described in the context of the SAP BW and Hyperion Essbase products, however the teachings of the present invention can be easily applied to other database systems and analysis tools.

Create DSN (Data Source Name)

Once the adapter and database front end is installed on a client computer. The Use-Case 400 begins when the user 402 creates a new DSN using the ODBC Data Source Administrator control panel (not shown). It is well known that DSN's provide connectivity to databases through an ODBC driver. One or more GUI dialogs will prompt for the system name, user name, password, client, and language to use for connecting to the warehouse. If incorrect login information is entered the user will continue to be prompted until they cancel out of creating the DSN or enter correct information.

Once the connection the warehouse is established, another dialog will display a list of catalogs and prompt for the catalog to use with the DSN. A DSN is created that can be used by the OLAP system.

Once the OLAP system is running. A new model is created or an existing model or outline created using the adapter is selected and open. A DSN create using the adapter is selected, user name and password are entered. The OLAP system is connected to the adapter and the selected model or outline is opened.

Generate XML Model

Once the OLAP system is running, and logged into the adapter. The flow of events is that he user selects a cube from a list of cubes in the catalog for the current DSN. The OLAP system executes a stored procedure within the adapter supplying the cube name selected. The adapter retrieves metadata information about the cube and performs the mapping outlined in a step described below under the title multidimensional to relational mapping. The adapter creates an XML model based on the mapping and returns the mapping from the stored procedure to the OLAP system. Once this is done the OLAP system will receive an XML model, which it can use to create the OLAP model for the cube.

Extract Data

Once the OLAP system is running and a meta-outline [NTD: what is a meta-outline] is loaded. The user selects to load members or data for the meta-outline. The OLPA system sends one or more SQL statements to the adapter specifying the data to retrieve. The adapter determines the tables requested in each SQL statement and executes one or more MDX statements to satisfy each SQL statement. The adapter transforms the results returned by multidimensional cube into tabular format and returns the table to the OLAP system. The selected data is extracted from the adapter into the OLAP system format.

Multidimensional to Relational Schema Mapping

This section outlines the mapping of cube/ODBO concepts to a relational schema. This mapping is performed so that the adapter can perform the steps of generating an XML model and extracting data as described above.

| Source (BW) | Target (Relational) |
|---|---|
| Catalog | Database |
| Cube | Table Owner (Schema) |
| n Dimensions of which there are m time | n − m + 1 Tables + 1 Fact Table |
| dimensions | |
| l Levels divided among k alternate | l Tables + k parent child tables |
| hierarchies (l >= k) | |

Table Description

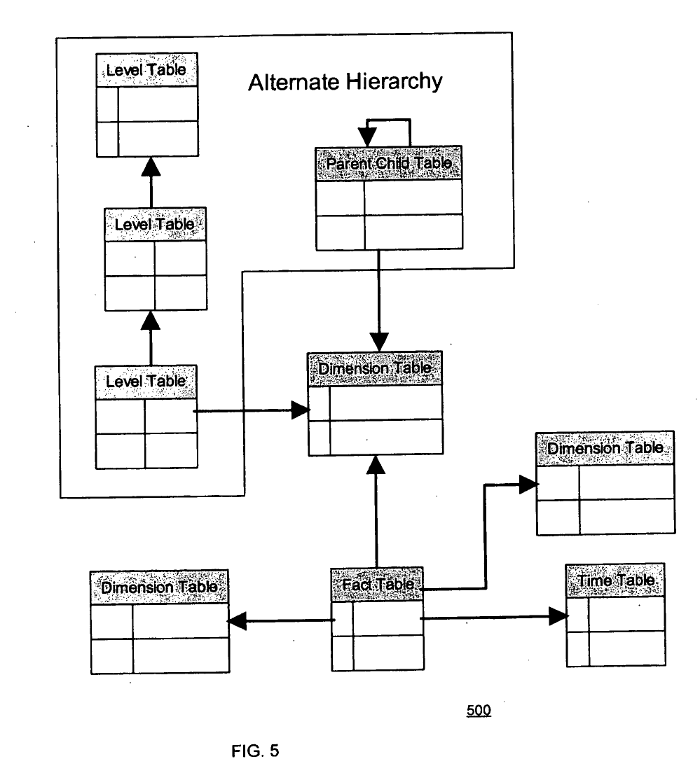

Referring to FIG. 5 there is shown a representation of a data source 202 cube using relational tables 500. The cube will be represented using a snowflake schema with the fact table at the center of the snowflake. Surrounding the fact table will be all of the dimension tables and the time table. All of the time dimensions will be collapsed into a single time table that will be joined to the fact table. The dimension tables represent the flat default hierarchy for the dimension. In SAP BW, all dimensions have a default hierarchy with one level. If a dimension has any alternate hierarchies then those hierarchies will be represented in two forms. First, each level in the alternate hierarchy will be represented as a table. The table representing the lowest level in the alternate hierarchy will be joined with the dimension table. In the second form, all members in the hierarchy will be represented in a parent child (or recursive) table where the hierarchy relationships are contained within member/child and parent columns.

Fact Table

In the embodiment illustrated in FIG. 5, the name for the fact table is FactTable. The table can be defined by the following:

i. One column for each measure. The name of the column will be the measure unique name. The column contents will be the measure data.

ii. One column for the time dimension. The name of the column will be the unique name of the largest time dimension. The column contents will be the unique names of the members from the largest time dimension. One column for each non-time dimension. The name of the column will be the unique name for the dimension. The column contents will be the unique names of the members from the dimension.

Dimension Tables

i. The name for each dimension table is the dimension unique name.

ii. Four columns that contain the member unique name, member name, member caption and description. The column names for each of these columns will be MemberUniqueName, MemberName, MemberCaption, MemberDescription.

iii. One column for each characteristic attribute. Characteristic attributes are represented as dimension properties within ODBO. The name of the column will be the dimension property name appended with the dimension property caption. The column contents will be the values for the dimension property.

All dimension properties will be represented. In ODBO there are dimension properties for the Key, Short text, Medium text, and Long text of the InfoObject. These properties will not be present because their values are available through the standard ODBO properties.

Level Tables

i. The name for each level table will be the level unique name.

ii. The columns for the level tables are the same as the dimension tables but may have an additional column that contains the parent unique name. The column name for this column will be ParentUniqueName. This column will not be present in the table representing the top level in a hierarchy.

Parent Child Tables

i. The name for the table will be the hierarchy unique name.

ii. The columns for the level tables are as the same as the dimension tables but include an additional column that contains the parent unique name. The column name for this column will be ParentUniqueName.

Time Table

i. The name for the time table will be Time.

ii. Each time dimension will have three columns that contain the member unique name, member name, and member caption. The column names for each of these columns will be MemberUniqueName, MemberName, MemberCaption.

iii. The time table will contain the non-empty crossjoin of the members from all time dimensions in the cube.

Time Representation

In contrast to Essbase, SAP BW uses multiple dimensions to represent time. The time dimensions will be combined into a single time table to allow building hierarchies. One side affect of the BW representation is that the hierarchies within the Essbase time dimension will need to be manually built.

Hierarchy Representation

Hierarchies are represented using a snowflake schema of one table for each level in the hierarchy. Hierarchies can also be represented using a parent-child or recursive table. The representation choice results in some trade offs. A snowflake representation supports hybrid analysis but only the leaves on the lowest level for ragged (or unbalanced in ODBO) hierarchies will contain data. Leaves that are not on the lowest level will not contain data. A parent-child representation supports ragged hierarchies but cannot be used for Hybrid Analysis.

In MDX, only one hierarchy from each dimension can be used in a query. As a result, the fact table can only contain members from one hierarchy for each characteristic. Within SAP BW each characteristic contains a default flat hierarchy that contains all of the members in the characteristic. As a result, the default hierarchy is a logical choice to use in the fact table. All other alternate hierarchies contain a subset of the members in the default hierarchy. Within an alternate hierarchy there are nodes that can be posted to and those that cannot. All nodes that refer to the characteristic that the hierarchy was created for are nodes that can be posted to. That is, transaction data exists only for nodes that can be posted to. Nodes that cannot be posted do not refer to the characteristic that the hierarchy has been created for. They are either text nodes that you can include in the hierarchy to improve the structure of the hierarchy or are external characteristic nodes. The nodes that can be posted to are also in the default flat hierarchy because they refer to the characteristic that the hierarchy was created for. As a rule, in a snowflake schema the lowest level in the alternate hierarchy contains the nodes that can be posted to. As a result, data is loaded for the alternate hierarchy by joining the lowest level in the alternate hierarchy with (1) the dimension table representing the default hierarchy and (2) the fact table.

Another representation of hierarchies is to flatten the hierarchy into a single table and use null promotion to ensure that all leaves are joined with dimension table. This approach is not taken because it is technically more difficult than the other two representations that are relatively easy to implement.

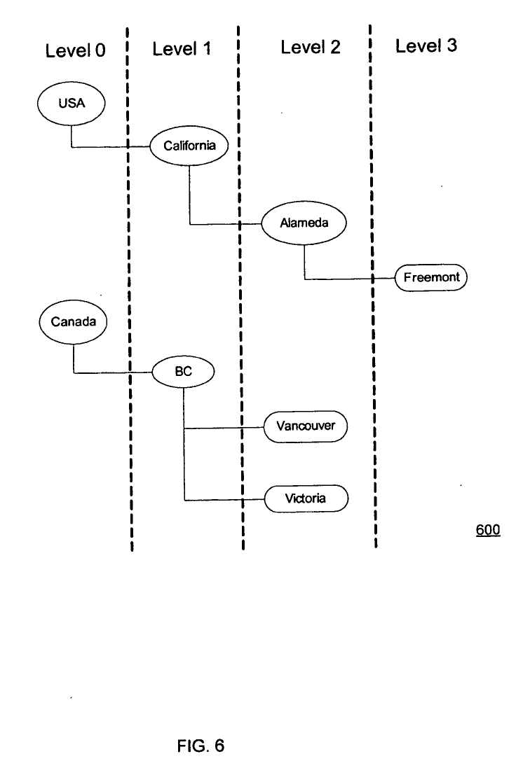

Referring to FIG. 6 there is shown a simple hierarchy 600 of countries (level 0), States/Provinces (Level 1), cities (level 2) and districts (level 3) for which the following tables result. Assume that the hierarchy is in the city characteristic and all other nodes are from external characteristics.

Parent Child Table

| Member | Parent |
|---|---|
| USA | <NULL> |
| Canada | <NULL> |
| California | USA |
| BC | Canada |
| Alameda | California |
| Vancouver | BC |
| Victona | BC |
| Freemont | Alameda |

Snowflake Table Level 0
Member

USA
Canada

Snowflake Table Level 1

| Member | Parent |
|---|---|
| California | USA |
| BC | Canada |

Snowflake Table Level 2

| Member | Parent |
|---|---|
| Alameda | California |
| Vancouver | BC |
| Victoria | BC |

Snowflake Table Level 3

| Member | Parent |
|---|---|
| Freemont | Alameda |

Flattened Hierarchy Table

| Level 0 | Level 1 | Level 2 | Level 3 |
|---|---|---|---|
| USA | California | Alameda | Freemont |
| Canada | BC | <NULL> | Vancouver |
| Canada | BC | <NULL> | Victoria |

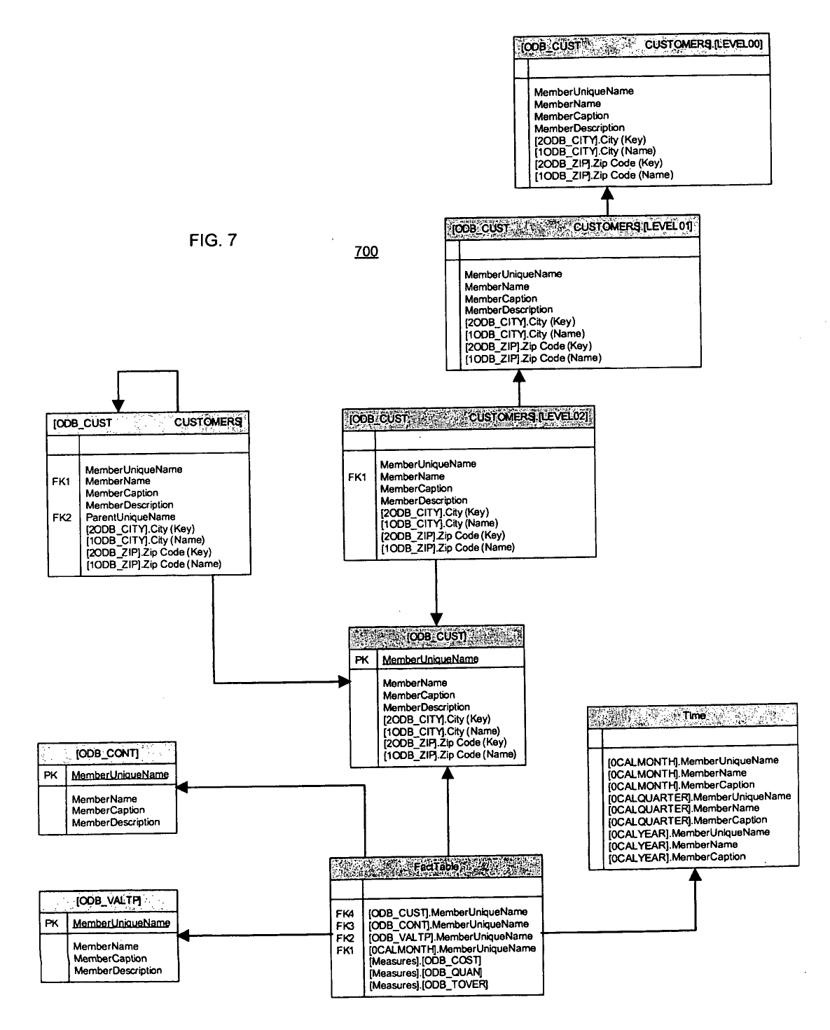

Referring to FIG. 7 there is shown a relational schema 700 that would be generated for a simple BW cube with 3 dimensions, and one hierarchy.

BW to Relational/XML Model Mapping

The following describes an implementation of the invention using SAP's BW/OBDO. Accordingly, the table below shows the mapping of the BW/ODBO items to both the relational and XML models.

| Source (BW/ODBO) | Target (Relational Model) | Target (XML Model) |
|---|---|---|
| Cube Name | Table Owner | Model element, name attribute |
| Cube Description | | Model element, desc attribute |
| Dimension Unique | | ModelDim element, name |
| Name¹ | | attribute |
| Time dimensions | Time table | ModelDim element, modelDim |
| | | attribute |
| | FactTable table | ModelDim element, modelDim |
| | | attribute |
| | | ModelLogicalJoin element, |
| | | view1 Name attribute |
| Dimension Unique | | ModelDim element, modelDim |
| Name¹ | | attribute |
| | | ModelView element, name |
| | | attribute |
| | | ModelLogicalJoin element, |
| | | viewiName attribute |
| Dimension Unique | Dimension table (for default | |
| Name | hierarchy) | |
| Level Unique | | ModelView element, name |
| Name¹ | | attribute |
| | | ModelLogicalJoin element, |
| | | viewiName attribute |
| Level Unique Name | Level table (for alternate | |
| | hierarchies) | |
| Hierarchy Unique | Parent child table | ModelHierarchy element, name |
| Name¹ | | attribute |
| | | ModelPhysicalJoin element, |
| | | table1Name attribute, |
| | | table2Name attribute |
| Level Number | | ModelHierarchy element, |
| | | levelNumber attribute |
| Member Unique | | ModelHierarchyMember |
| Name¹ | | element, viewMemberName |
| | | attribute |
| Member Unique | Column in fact, dimension, | ModelViewMember element, |
| Name | parent child, level tables (used | name attribute |
| | to join dimension table to | ModelLogicalJoin element, |
| | lowest level table) | memberiName attributes |
| | | ModelPhysicalJoin element, |
| | | column1Name attribute |
| Member Name | Column in dimension, parent | ModelViewMember element, |
| | child, level tables | name attribute |
| | | ModelLogicalJoin element, |
| | | memberiName attributes |
| Member Caption | Column in dimension, parent | ModelViewMember element, |
| | child, level tables | name attribute |
| Member | Column in dimension, parent | ModelViewMember element, |
| Description | child, level tables | name attribute |
| Parent Unique | Column in level tables, parent | ModelViewMember element, |
| Name | child tables | name attribute |
| | | ModelPhysicalJoin element, |
| | | column2Name attribute |
| Property Name | Columns in dimension, parent | ModelViewMember element, |
| concatenated with | child, level tables | name attribute |
| Property Caption | | |
| (dimension | | |
| properties)¹ | | |
| Property Name | Columns in dimension, parent | ModelViewMember element, |
| (dimension | child, level tables | drillthrough type attribute |
| properties) | | |
| Measure Unique | Column in fact table | ModelViewMember element, |
| Name¹ | | name attribute |
| Measure Aggregator | | ModelViewMember element, |
| | | aggregateType attribute |

Captions may be used instead of unique names. The unique name is the technical name whereas the caption is the ‘friendly’ name. Note that not all characteristics will have ‘friendly’ names. As a result, the technical name is used instead.

Data Flow

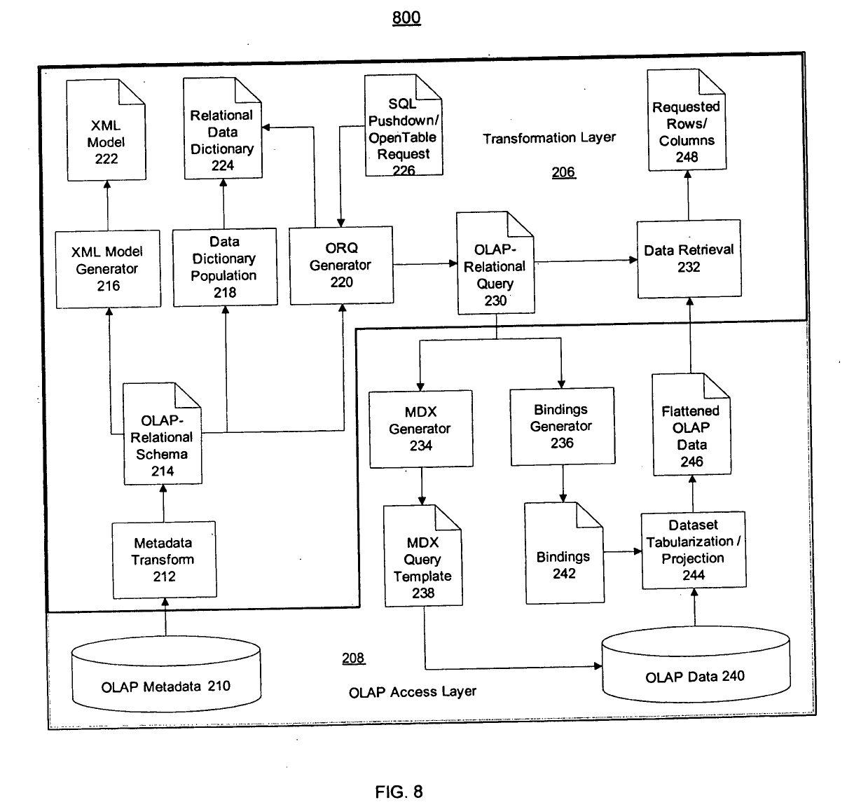

Referring to FIG. 8 there is shown a conceptual flow diagram 800 of the DRM 200 according to an embodiment of the present invention. In this diagram , “document” shapes represent conceptual data artifacts (data structures), rectangle shapes represent transformations on those artifacts and arrowed lines denote a direction of data flow. Arrowed lines leading into a rectangle represent inputs to a transformation and arrowed lines leading out of a rectangle represent outputs from a transformation. Shaded data and transformation shapes represent respective data structures and transformations that are independent of the semantics of the underlying data. In other words, no assumptions are made about the OLAP data source such as SAP BW or the relational target such as for example Hyperion EIS. The dashed lines represent layer boundaries of the adapter driver.

The adapter 180 performs two broad functions, namely i) metadata mapping to transform OLAP metadata 210 to a relational schema having either a star or snowflake configuration and an XML model for the OLAP system and ii) data mapping using available metadata to translate requests to fetch relational data (i.e.—SQL queries) into requests for OLAP data, and then transform fetched OLAP data to the requested relational form.

The data artifacts that the adapter 180 produces include i) a relational data dictionary 224 that provides a snowflake schema corresponding to an OLAP cube; ii) an XML model 222 corresponding to an OLAP cube and iii) relational result sets for SQL queries issued by the OLAP system (not shown).

The following sub-sections describe detail of each step of the data flow in the adapter 180.

Metadata Transform 212

Inputs: OLAP Metadata 210; Outputs: OLAP Relational Schema 214

The metadata transform step 212 builds an OLAP-Relational schema 214 from OLAP metadata 210 for a particular cube (not shown). It is responsible for applying any business logic required in order to ensure that OLAP-to-relational mapping is meaningful. In other words, it ensures that there is as little loss of business semantics in the conversion process. For example, for a SAP BW implementation the metadata transform for the adapter will construct an appropriate schema for the Time dimension table based on the unique way in which SAP BW represents time (i.e.—as separate dimensions).

OLAP-Relational Schema 214

This data structure describes a star or snowflake schema in both relational and OLAP terms. It includes such information as tables, columns, joins, cubes, levels, hierarchies, dimensions, measures, and properties. The OLAP-relational schema 214 provides enough information for the rest of the adapter 180 to correctly perform the required OLAP-to-relational mappings.

XML Model Generator 216

Inputs: OLAP-Relational Schema 214; Outputs: XML Model 222

This step builds the XML model 222 for consumption by the relational target. All information required to construct the model is obtained from an OLAP-relational schema 214.

XML Model 222

This data structure is an XML document that conforms to the model DTD defined by the specific relational cube being connected to. It contains metadata describing a relational schema constructed by the adapter 180 from the OLAP cube.

Data Dictionary Population 218

Inputs: OLAP Relational Schema 214; Outputs: Relational data Dictionary 224

The Data Dictionary Population 218 step populates the relational data dictionary 224 with relational metadata obtained from the OLAP-relational schema 214. This includes primarily table and column metadata.

Relational Data Dictionary 224

This is a collection of virtual tables containing metadata that describe only the relational aspects of a particular snowflake schema.

SQL Pushdowns/Open Table Request 226

From the point of view of the adapter 180, the request is either a SQL pushdown (optimized case) or open-table request for a base table (non-optimized case) from an query engine 186 (such as the Simba Engine). Both ultimately originate from a SQL statement issued by the data consumer that is subsequently processed by the query engine 186 portion of the adapter. For the sake of simplicity, a request to open a table T can be considered to be conceptually equivalent to the SQL query select * from T.

ORQ Generator 220

Inputs: OLAP Relational schema 214; SQL Pushdowns/Open Table Request 226; Outputs: OLAP Relational Query (ORQ) 230; update Relational Data Dictionary 224

The ORQ Generator 220 step creates the ORQ 230 that describes the OLAP data to fetch and how to transform it into the required relational form. It handles requests for base tables, as well as pushdown requests that produce derived tables implementing various optimization techniques. This step will take the OLAP-relational schema 214 as input. From this, it will identify the OLAP metadata corresponding to the relational table that it must create, whether that table is a base table or a derived (i.e.—optimized) table. This metadata is used to produce an ORQ 230 that describes the OLAP data to fetch. As a side effect of creating a new derived table in the optimized case, this step also updates the Relational data dictionary 224 with a descriptor for the new table.

OLAP-Relational Query (ORQ) 230

This is a query-like specification that describes the OLAP data to fetch as well as the relational structure in which the fetched data must be formatted. In general, it acts as a query that is executed by the OLAP access layer 156. The ORQ 230 carries enough information to generate MDX queries that fetch OLAP data 240 from the cube, as well as to generate bindings that apply projections and data type conversions to resulting axis rowset and cell data.

The ORQ 230 assumes the Command role of the Command design pattern [GoF95]. It may be implemented as an object structure rather than as raw text, in accordance with the Composite pattern [GoF95].

MDX Generator 234

Inputs: ORQ 230; Outputs: MDX Query Template 238

The MDX Generator 234 takes an ORQ 230 as input and generates a “template” of an MDX query 238. The template 238 can be “instantiated” multiple times to create MDX statements that fetch partitions of the OLAP data specified by the ORQ.

MDX Query Template 238

This is an incomplete MDX SELECT statement that is created by the MDX Generator 234 using the ORQ 230. It is parameterized by partition size and partition starting ordinal. Once these parameters are provided, the template query becomes a complete MDX query that retrieves one partition of the OLAP data 240 indicated by the ORQ 230.

Bindings Generator 236

Inputs: ORQ 220; Outputs: Bindings 242

This step takes an ORQ 230 as input and generates bindings that apply column projections and data type conversions to the ROWS axis rowset and cell data fetched from the OLAP data source.

Bindings 242

The bindings data structure 242 describes the columns to extract from the ROWS axis rowset and cell data, as well as the desired target data type. Note that this structure is very low-level in nature, since it describes the details of buffer layout and assumes knowledge of the structure of the dataset returned by the OLAP provider. This structure is produced by the Bindings Generator 236 and is applied to the OLAP data 240 in the Dataset Tabularization/projection 244 step.

Dataset Tabularization/Projection 244

Inputs: OLAP Data 240; Outputs: Flattened OLAP data 246

The Dataset Tabularization/Projection 244 step takes one partition of OLAP data 240 in the form of a dataset as input. In the case of a dimension table, this dataset will include a ROWS axis and an empty COLUMNS axis. In the case of a fact table, the COLUMNS axis will contain measures and there will be cell data as well. To create a partition of a dimension table, this step will simply apply the appropriate bindings to the ROWS axis rowset. To create a partition of a fact table, this step must first pivot the COLUMNS axis rowset to create measure columns, and then combine the cell data with the rows from the ROWS axis rowset. The result is a partition of OLAP data in “flattened” two-dimensional form.

Flattened OLAP Data 246

The Flattened OLAP Data 246 data structure contains a single partition of OLAP data in flattened form. It is structured according to the form specified by the original ORQ 230. This data structure is not necessarily relational in the sense that it may contain additional OLAP metadata. In addition, its data may require further conversion and transformation before it matches the corresponding dimension/fact table in the data dictionary. This data structure is produced by the Dataset tabularization/projection step 244, and is the primary output of the data-access portion of the OLAP access layer 156.

Data Retrieval 232

Inputs: Flattened OLAP data 246; Outputs: Requested rows/columns 248

This step accesses OLAP data 240 on a block-by-block basis. It creates each block from a partition of flattened OLAP data retrieved from the OLAP access layer 156. For each block, this step provides its rows and columns to the RDBM engine via the DRM layer.

Requested Rows/Columns 248

This is the collection of rows and columns requested by the data consumer via the query engine 186.

The following describes some of the data structures mentioned above in greater detail.

OLAP-Relational Query (ORQ)

As described briefly above, the OLAP-Relational Query (ORQ) is a mapping from the relational model to the multidimensional model. It is used to represent a SQL query in a form that can be easily translated to an MDX query. It contains all of the information required to generate a syntactically valid MDX query. As a result, the data dictionary or OLAP-relational schema is not used to transform an ORQ into an MDX query. There are five types of ORQ queries to represent the five possible types of relational tables in the OLAP-relational schema.

i. A composite query which is used to represent a table composed of multiple dimensions (for example, the Time table in the case of SAP BW).

ii. A multilevel query which is used to represent a table composed of multiple levels from a single dimension. Currently, OLAP-relational schemas for SAP BW cubes do not contain any multiple-level tables.

iii. A level query which is used to represent a table composed of a single level from a dimension such as the dimension and level tables in the relational snowflake model.

iv. A parent-child query which is used to represent a parent-child table composed of a single hierarchy in a dimension.

v. A fact query which is used to represent the fact table.

ORQ optimizations allow translating aggregate functions, arithmetic operations, join conditions, filters, and group-by's from SQL into MDX. The following are examples of each of the types of ORQ's queries described above:

```
i. select composite
    level <<level>> in hierarchy <<hier>> in dimension <<dim1>> as
      <<attr1>>, ..., <<attri₁>>
    ...
    level <<level>> in hierarchy <<hier>> in dimension <<dimn>> as
      <<attr1>>, ..., <<attriₙ>>
  from cube <<cube>>
ii. select multilevel
    level <<level1>> as
      <<attr1>>, ..., <<attri₁>>
    ...
    level <<leveln>> as
      <<attr1>>, ..., <<attriₙ>>
  from hierarchy <<hier>> in dimension <<dim>> in cube <<cube>>
iii. select level
    <<attr1>>, ..., <<attri>>
  from level <<level>> in hierarchy <<hier>> in dimension
  <<dim>> in cube <<cube>>
  select parentchild
    <<attr1>>, ..., <<attri>>
  from hierarchy <<hier>> in dimension <<dim>> in cube <<cube>>
iv. select fact
    level <<level>> in hierarchy <<hier>> in dimension <<dim1>> as
      <<attr1>>, ..., <<attri₁>>
    ...
    level <<level>> in hierarchy <<hier>> in dimension <<dimn>> as
      <<attr1>>, ..., <<attriₙ>>
    measures as
      <<measure1>>, ..., <<measurej>>
  from cube <<cube>>
```

MDX Equivalencies

The following are the equivalent MDX queries that are generated for each ORQ type. Note that the syntax and features used in these queries are specific to SAP BW.

i. Composite

```
with set rowsAxisSet as
  ‘crossjoin( <<dim1_level>>.members,
  crossjoin( ...,
    crossjoin( <<dimn−1_level>>.members, <<dimn_level>>.members )
    ...
  )
  )’
select { } on columns,
  non empty subset( rowsAxisSet, startOrdinal, partitionSize )
  dimension properties
    <<dim1_attr1>>, ..., <<dim1_attri₁>>,
    <<dim2_attr1>>, ..., <<dimn_attriₙ>>
  on rows
from <<cube>>
```

```
with set rowsAxisSet as
  ‘hierarchize( {<<level1>>.members, ..., <<leveln>>.members} )’
select { } on columns,
  non empty subset( rowsAxisSet, startOrdinal, partitionSize )
  dimension properties
    <<level1_attr1>>, ..., <<level1_attri₁>>,
    <<level2_attr1>>, ..., <<leveln_attriₙ>>
  on rows
from <<cube>>
```

```
with set rowsAxisSet as ‘<<level>>.members’
select { } on columns,
  non empty subset( rowsAxisSet, startOrdinal, partitionSize )
  dimension properties <<attr1>>, ..., <<attri>>
  on rows
from <<cube>>
```

```
with set rowsAxisSet as ‘<<hier>>.members’
select { } on columns,
  non empty subset( rowsAxisSet, startOrdinal, partitionSize )
  dimension properties <<attr1>>, ..., <<attri>>
  on rows
from <<cube>>
```

v. Fact

```
with
  set rowsAxisSet as
  ‘crossjoin( <<dim1_level>>.members,
    crossjoin( ...,
        crossjoin( <<dimn−1_level>>.members,
        <<dimn_level>>.members )
      ...
    )
  )’
  set measuresSet as ‘{<<measure1>>, ..., <<measurej>>}’
select measuresSet on columns,
  non empty subset( rowsAxisSet, startOrdinal, partitionSize )
  dimension properties
      <<dim1_attr1>>, ..., <<dim1_attri₁>>,
      <<dim2_attr1>>, ..., <<dimn_attriₙ>>
  on rows
from <<cube>>
```

OLAP-Relational Schema 214

The OLAP-relational schema is a data structure that describes a synthetic relational snowflake schema in terms of the OLAP metadata from which it originates as described above. It is organized primarily as a “logical” OLAP schema, with links to its corresponding physical OLAP schema and relational schema.

The following table is a representation of a cube:

| Dimension | Hierarchy | Level | Attributes |
|---|---|---|---|
| Product | ByCategory | Category | |
| | | ProductName | Color, Size |
| | ByManufacturer | Manufacturer | |
| | | Brand | |
| | | ProductName | Color, Size |
| Geography | Default | Country | |
| | | Region | |
| | | City | Population |
| Time | Default | Year | |
| | | Quarter | |
| | | Month | |

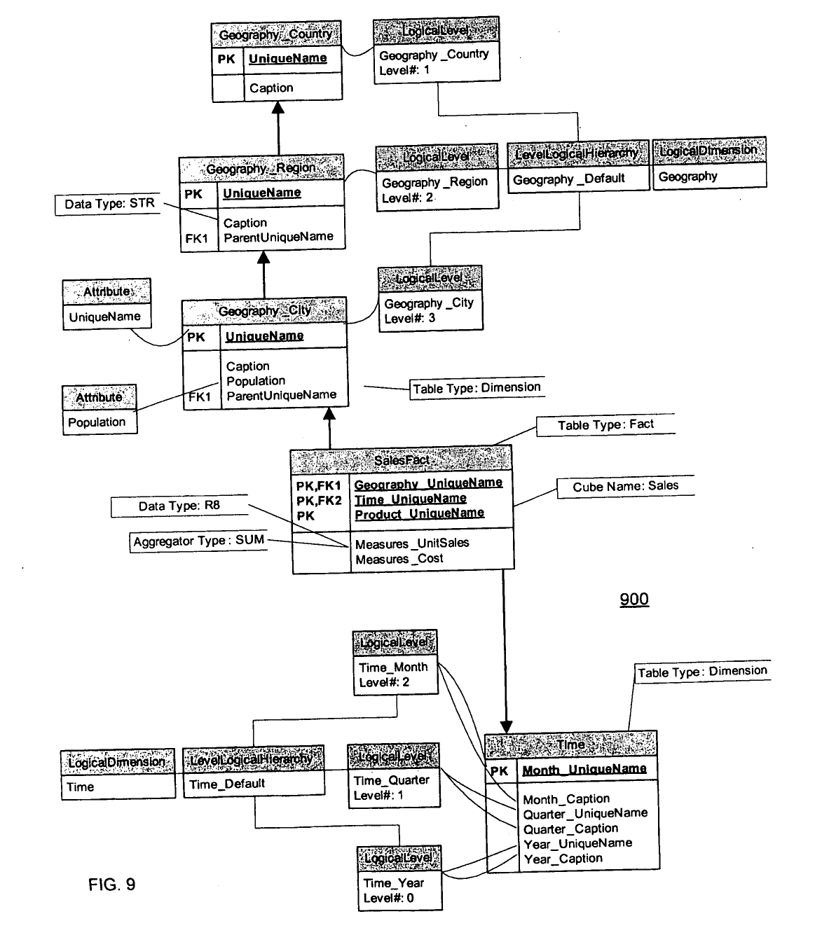

Assume that this cube is named “Sales” and has two measures: “UnitSales” and “Cost”. Also assume that every level defines the attributes “UniqueName” and “Caption” for each member, and that “UniqueName” uniquely identifies each member. Note that this is a generic example of OLAP metadata and does not reflect the structure of SAP BW metadata. FIG. 9 illustrates a portion of one implementation of an, OLAP-relational schema 900 for this cube which shows some of the common types of information that will be associated with parts of the snowflake schema. Three items of note in the above diagram are the LogicalDimension, LevelLogicalHierarchy, and LogicalLevel OLAP structures. These represent a logical OLAP schema that represents a particular configuration of the physical OLAP schema for presentation as a relational schema. These configurations correspond to the ORQ types defined above i.e.—composite, multilevel, level, and parent-child). The “LevelLogicalHierarchy” is named to distinguish it from a physical hierarchy, and from other logical hierarchy types. A physical hierarchy in this context is a hierarchy that is extracted from the OLAP metadata. A logical hierarchy is one that is constructed by the metadata transform step in order to preserve business semantics from the underlying OLAP metadata. A logical hierarchy may or may not correspond to a physical hierarchy. For example, the logical hierarchies used to construct the composite Time table for SAP BW cubes does not correspond to a single physical hierarchy.

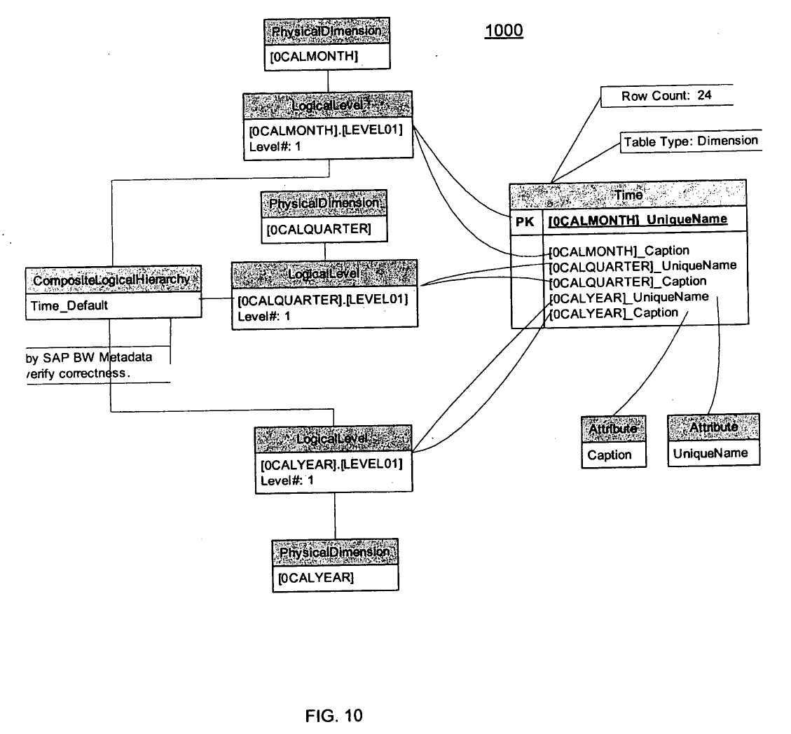

FIG. 10 illustrates part of the OLAP-relational schema for an SAP Time table 1000. Note the use of “CompositeLogicalHierarchy” in this example. Each of its levels actually belongs to a different physical hierarchy. The creation of “CompositeLogicalHierarchy” structures is partly guesswork on the part of the driver. For this reason, a warning will be embedded as comments in the XML model sent to EIS.

The example above also includes an optimization-related annotation: a row count. Where possible, exact or approximate row counts will be determined by the metadata transform and included in the OLAP-relational schema for the benefit of the ORQ generator.

SQL to MDX Mapping

The following provides examples of mapping from SQL to MDX for a simple star schema based on the ODBSCEN01 cube and four dimensions, ODB_CUST, ODB_CONT, ODB_VALTP, 0CALMONTH. The SQL examples are based on what EIS may generate during a member or data load. Where MDX cannot perform the operations required a note is made stating that SEN will perform the required SQL operation.

This following show the mapping by listing one or more SQL queries followed by an MDX query that produces the results required to satisfy the SQL query.

Distinct

If one of the columns specified in the Distinct clause is unique then the Distinct clause can be removed from the query. Note that the MemberUniqueName column is not unique within alternate hierarchies.

Arithmetic Operations

SEN will need to perform the calculations required by % (modulus).

Scalar functions

SEN will need to perform the calculations required by scalar functions.

Aggregates

All of the four SQL queries below will result in the same MDX query.
Select Count(MemberCaption) From [OBD_CUST]
select Count (MemberUniqueName) from [ODB_CUST]
Select Count (*) from [ODB_CUST]
Select Count (Distinct (MemberName)) from [ODB_CUST]
with member [Measures].[CountX] as ‘Count([ODB_CUST].[LEVEL01].members)’ select {[Measures].[CountX]} on columns from [$ODBSCEN01]

If the clause is Distinct MemberCaption then it cannot be counted. Count distinct can only be done if the columns specified are unique.

The consumer of the data can connect to the adapter via any one of the following standard APIs: ODBC, JDBC, OLE DB, ADO, or ADO.NET. The consumer will be able to issue meta-data queries to the adapter to get information about the star/snowflake virtual view of the cube. The consumer will generate SQL queries that will be executed against the data provider. The multidimensional data source exposes its data via either ODBO (OLE DB for OLAP) or XMLA (XML for analysis) and executes MDX queries passed to it and returns the data resulting from the input MDX queries.

The translation of an SQL query to an MDX query operates by presenting the data consumer with a data source that is represented as star/snowflake rather than a cube. Therefore, the consumer will launch a SQL query against the star/snowflake. To expose the cube as a star/snowflake, the adapter reads the meta-data of the cube and using a transform algorithm presents the consumer with a star/snowflake in a specified form. Of course, the star/snowflake does not really exist; it is a set of virtual tables. Then, when the consumer executes a SQL statement against the virtual star/snowflake, the adapter will map the SQL to the appropriate MDX statements.

In summary the adapter according to the present invention provides a high degree of correctness, in that the member and fact data being returned by the adapter must be correct and the relational schema presented must allow the relational target (eg EIS) to create a cube in the destination database (eg Essbase) that closely matches the source cube (eg SAP BW). Although the adapter transfers data in a timely and efficient manner, it may not be as fast as loading data from a relational database. Other features of the adapter are its scalability, portability flexibility and maintainability.

Although the invention has been shown and described with respect to a certain preferred aspect or aspects, it is obvious that equivalent alterations and modifications will occur to others skilled in the art upon the reading and understanding of this specification and the annexed drawings. In particular regard to the various functions performed by the above described items referred to by numerals (components, assemblies, devices, compositions, etc.), the terms (including a reference to a “means”) used to describe such items are intended to correspond, unless otherwise indicated, to any item which performs the specified function of the described item (e.g., that is functionally equivalent), even though not structurally equivalent to the disclosed structure which performs the function in the herein illustrated exemplary aspect or aspects of the invention. In addition, while a particular feature of the invention may have been described above with respect to only one of several illustrated aspects, such feature may be combined with one or more other features of the other aspects, as may be desired and advantageous for any given or particular application.

The description herein with reference to the figures will be understood to describe the present invention in sufficient detail to enable one skilled in the art to utilize the present invention in a variety of applications and devices. It will be readily apparent that various changes and modifications could be made therein without departing from the spirit and scope of the invention as defined in the following claims.

1. A method for mapping a data sources of an unknown configuration to that of a known configuration, comprising the steps of:
a. submitting a request for metadata to said data source;
b. generating a relational schema of said known configuration based on the metadata received from said data sources; and
c. returning the metadata of said generated relational schema, the returned metadata mapping the data source to the known configuration.

2. A method as defined in claim 1, said data source of an unknown configuration being a multidimensional database.

3. A method as defined in claim 1, said known configuration being a star or snowflake schema.

4. A method as defined in claim 1, including the steps of:
a. receiving, from a data consumer, a query for data against said generated relational schema;
b. translating the received query to one or more queries supported by the data sources for retrieval of data from the data sources; and
c. returning the data retrieved from said data sources to the data consumer.

5. A method for translating a query submitted to a data source, wherein the query is in an unsupported language of the data source, said method comprising:
a. receiving a query from a data consumer, the query based on a relational schema of a known configuration, wherein the schema maps the data sources to the known configuration;
b. translating the received query to one or more queries supported by the data sources for retrieval of data from the data sources; and
c. returning the data retrieved from said data sources to the data consumer.

6. A method as defined in claim 3, said query being a Structured Query Language (SQL) query and said data source being a multidimensional database.

7. A method as defined, in claim 4, said multidimensional database supporting a Multi Dimensional expression language (MDX).

8. A method as defined in claim 5, said known configuration being a star or snowflake.

9. A method as defined in claim 3, said data sources being a collection of cubes.

10. A method as defined in claim 3, said query being an SQL query against said star/snowflake.

11. A method for translating a query, issued by a data consumer in an unsupported language of the data sources, to that of the data source supporting language, said method comprising:
a. presenting a data consumer with a relational schema of a known configuration;
b. using a transform algorithm to present the data consumer with said data source in said known configuration.
c. reading a metadata model containing model objects that represent the data sources;
d. receiving a query against said known configuration.; and
e. returning the data retrieved from said data sources to the data consumer.

12. A method as defined in claim 9, said query being a structured query language (SQL) query and said data source being a multidimensional database.

13. A method as defined, in claim 10, said data source supporting language being Multi Dimensional Expression language (MDX).

14. A method as defined in claim 11, said known configuration being a star/snowflake.

15. A method as defined in claim 12, said query being an SQL query against said star/snowflake.

16. An adapter for translating a query, issued by a data consumer in an unsupported language of a data sources, to that of the data source supporting language, said adapter comprising:
a. means for generating a relational schema of a known configuration;
b. an interface for receiving a query against said known configuration;
c. a metadata model containing model objects that represent the data sources;
d. a transform algorithm for presenting the data consumer with said data source in said known configuration.

17. A an adapter as defined in claim 14, said adapter being an SQL driver including one of an ODBC driver, an JDBC driver or an OLE-DB provider.
